(19) United States
(12) Patent Application Publication
(10) Pub. No.: US 2023/0376809 A1
(43) Pub. Date: Nov. 23, 2023

(54) BALANCING AN IMPROVEMENT IN A PREDICTED LIKELIHOOD OF USER INTERACTION WITH CONTENT IN AN ONLINE SYSTEM AGAINST A LATENCY REQUIRED TO OBTAIN THE IMPROVED PREDICTION

(71) Applicant: Meta Platforms, Inc., Menlo Park, CA (US)

(72) Inventors: Andrew Donald Yates, San Francisco, CA (US); Matthew David Stone, Danville, CA (US)

(21) Appl. No.: 15/883,005

(22) Filed: Jan. 29, 2018

(51) Int. Cl. G06N 7/00; G06N 5/02

(52) U.S. Cl. CPC G06N 7/005; G06N 5/02

(57) ABSTRACT

An online system ranks content eligible for presentation to an online system user based on a prediction made by a general model or a specific model indicating a likelihood that the user will interact with a content item, in which the specific model has a higher latency than the general model. The online system determines which prediction to use for the ranking by balancing the benefit of a more accurate prediction made by the specific model against the higher latency of the specific model. The online system outputs the predicted likelihood from one of the models based on the determination, ranks content items eligible for presentation to the user based on the output, and selects content item(s) for presentation to the user based on the ranking. The online system may log the predicted likelihoods from both models, the outputted predicted likelihood, and information describing the performance of the content item.

### BACKGROUND

This disclosure relates generally to online systems, and more specifically to balancing an improvement in a predicted likelihood of user interaction with content in an online system against a latency required to obtain the improved prediction.

An online system allows its users to connect and communicate with other online system users. Users create profiles in the online system that are tied to their identities and include information about the users, such as interests and demographic information. The users may be individuals or entities such as corporations or charities. Because of the popularity of online systems and the significant amount of user-specific information maintained in online systems, an online system provides an ideal forum for content-providing users to share content by creating content items (e.g., advertisements) for presentation to additional online system users. For example, content-providing users may share photos or videos they have uploaded by creating content items that include the photos or videos that are presented to additional users to whom they are connected in the online system. By allowing content-providing users to create content items for presentation to additional online system users, an online system also provides abundant opportunities to persuade online system users to take various actions and/or to increase awareness about products, services, opinions, or causes among online system users. For example, if a content-providing user of the online system who volunteers for a non-profit organization creates a content item encouraging additional online system users to volunteer for the non-profit organization, the online system may present the content item to these additional online system users.

Conventionally, online systems generate revenue by displaying content to their users. For example, an online system may charge advertisers for each presentation of an advertisement to an online system user (i.e., each “impression”) or for each interaction with an advertisement by an online system user (e.g., each click on the advertisement, each purchase made as a result of clicking through the advertisement, etc.). Furthermore, by presenting content that encourages user engagement with online systems, online systems may increase the number of opportunities they have to generate revenue. For example, if an online system user scrolls through a newsfeed to view content that captures the user's interest, advertisements that are interspersed in the newsfeed also may be presented to the user.

To present content that encourages user engagement with online systems, online systems may select content items for presentation to online system users that are likely to be relevant to the users. Online systems may do so by predicting likelihoods that users will interact with various content items and select content items associated with the highest likelihoods for presentation to the users. For example, an online system may estimate a click-through-rate or a conversion rate associated with a content item for a particular user of the online system, rank the content item among additional content items eligible for presentation to the user based on the estimated rate, and select the highest ranked content item for presentation to the user. The online systems may predict the likelihoods using various models (e.g., machine-learning models) that are trained based on features associated with content-providing users of the online system and attributes for users of the online system to whom the content items may be presented. Furthermore, the accuracy of these predictions often may be improved if the models are trained based on features that are specific to a set of content-providing users of the online system (e.g., an industry associated with the content-providing users), increasing the likelihood of user engagement with content items selected based on these predictions.

However, additional time often is required in order to obtain more accurate predictions, which may result in delays in the presentation of content items to online system users and may discourage user engagement with online systems.

### SUMMARY

An online system ranks content (e.g., content items or advertisements) that may be presented to viewing users of the online system based on predictions made by a general model and a specific model (e.g., machine-learning models that are trained based on features maintained in the online system). Each pair of predictions made by the models indicate a likelihood that a viewing user will interact with a content item (e.g., as an estimated click-through-rate or an estimated conversion rate). Furthermore, the specific model has a higher latency than the general model (i.e., the amount of time elapsed between the time the online system identifies an opportunity to present content to the viewing user and the time the likelihood is predicted is greater for the specific model than for the general model). To determine which prediction to use to rank content items, the online system accesses a control setting that balances the benefit of a more accurate prediction made by the specific model against the higher latency of the specific model and indicates whether the online system should wait for the specific model to predict the likelihood. The online system may output the predicted likelihood from the general model or the specific model based on the control setting and rank content items eligible for presentation to the viewing user using the outputted predicted likelihood or values (e.g., scores or bid amounts) derived from the outputted predicted likelihood. The online system then selects a content item for presentation to the viewing user based on the ranking in a content selection process. The online system may log the predicted likelihood from the general model, the predicted likelihood from the specific model, the outputted predicted likelihood, and/or information describing the performance of the content item presented to the viewing user (e.g., click-through rate, conversion rate, etc.).

In some embodiments, the specific model may have a higher latency than the general model because the specific model refines the likelihood predicted by the general model. In other embodiments, the specific model may have a higher latency than the general model because the specific model is more complex than the general model and therefore requires more time to predict the likelihood. The specific model may be more complex than the general model for various reasons (e.g., the specific model may be trained based on features that are not used to train the general model, the specific model may require more inputs than the general model, the specific model and the general model may correspond to different types of machine-learning models, etc.).

In some embodiments, the online system may determine the control setting used to determine which prediction to use. In such embodiments, the online system may determine the control setting by comparing the accuracies of the predictions (e.g., by comparing their error rates). Based on the comparison, the online system may compute a metric (an “accuracy comparison metric”) that measures an increased accuracy of the predicted likelihoods from the specific model compared to the predicted likelihoods from the general model. The online system may then determine the control setting based on the accuracy comparison metric, such that the control setting indicates that the online system should wait for the specific model to predict the likelihood if the accuracy comparison metric is above a threshold (e.g., a threshold error rate) and indicates that the online system should not wait for the specific model to predict the likelihood otherwise. In various embodiments, the online system also may determine the control setting based on additional factors (e.g., stabilization of the accuracy comparison metric, a random selection process that outputs the predicted likelihood from the general model, and historical performance information that indicates whether the quality of the predictions made by the specific model has degraded).

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flow chart of a method for balancing an improvement in a predicted likelihood of user interaction with a content item in an online system against a latency required to obtain the improved prediction, in accordance with an embodiment.

FIG. 4A illustrates an example of balancing an improvement in a predicted likelihood of user interaction with a content item in an online system against a latency required to obtain the improved prediction, in accordance with an embodiment.

FIG. 4B illustrates an additional example of balancing an improvement in a predicted likelihood of user interaction with a content item in an online system against a latency required to obtain the improved prediction, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

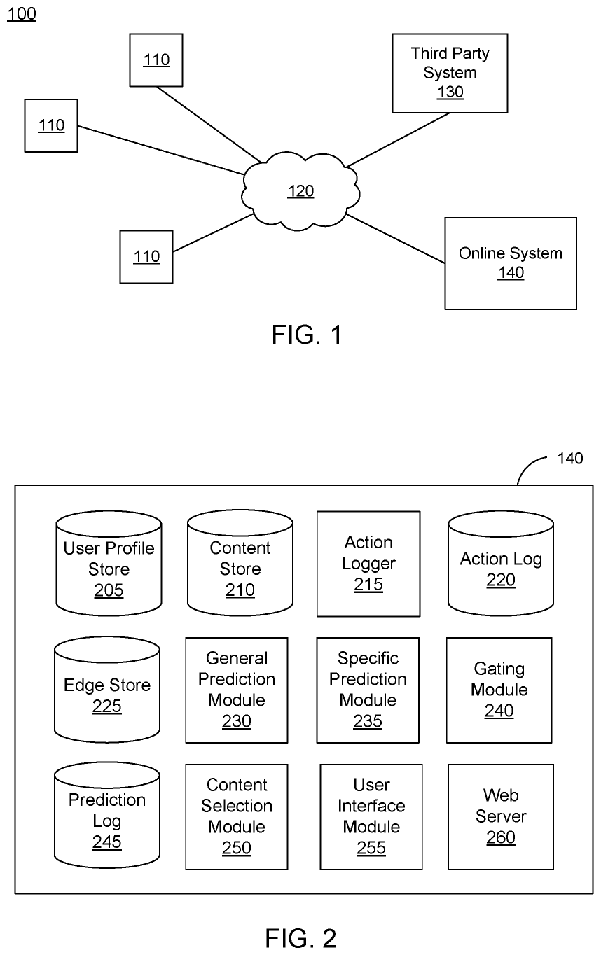

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

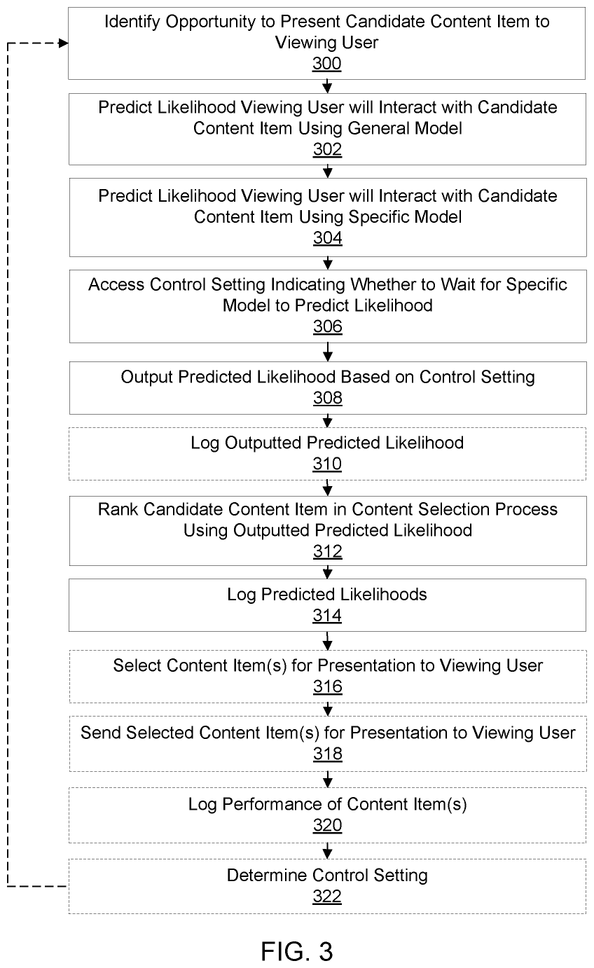

One or more third-party systems 130 may be coupled to the network 120 for communicating with the online system 140, which is further described below in conjunction with FIG. 2. In one embodiment, a third-party system 130 is an application provider communicating information describing applications for execution by a client device 110 or communicating data to client devices 110 for use by an application executing on the client device 110. In other embodiments, a third-party system 130 (e.g., a content publisher) provides content or other information for presentation via a client device 110. A third-party system 130 also may communicate information to the online system 140, such as advertisements, content, or information about an application provided by the third-party system 130.

FIG. 2 is a block diagram of an architecture of the online system 140. The online system 140 shown in FIG. 2 includes a user profile store 205, a content store 210, an action logger 215, an action log 220, an edge store 225, a general prediction module 230, a specific prediction module 235, a gating module 240, a prediction log 245, a content selection module 250, a user interface module 255, and a web server 260. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and also may include profile information inferred by the online system 140. In one embodiment, a user profile includes multiple data fields, each describing one or more user attributes for the corresponding online system user. Examples of information stored in a user profile include biographic, demographic, and other types of descriptive information, such as work experience, educational history, gender, hobbies or preferences, locations and the like. A user profile also may store other information provided by the user, for example, images or videos. In certain embodiments, images of users may be tagged with information identifying the online system users displayed in an image. A user profile in the user profile store 205 also may maintain references to actions by the corresponding user performed on content items in the content store 210 and stored in the action log 220.

While user profiles in the user profile store 205 are frequently associated with individuals, allowing individuals to interact with each other via the online system 140, user profiles also may be stored for entities such as businesses or organizations. This allows an entity to establish a presence in the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), an advertisement, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions in the online system 140, as well as actions in the third-party system 130 that communicate information to the online system 140. Users may interact with various objects in the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects in the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements in the online system 140 as well as with other applications operating in the online system 140. In some embodiments, data from the action log 220 is used to infer interests or preferences of a user, augmenting the interests included in the user's user profile and allowing a more complete understanding of user preferences.

The action log 220 also may store user actions taken on a third-party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third-party system 130, including webpage viewing histories, advertisements that were engaged, purchases made, and other patterns from shopping and buying. Additionally, actions a user performs via an application associated with a third-party system 130 and executing on a client device 110 may be communicated to the action logger 215 for storing in the action log 220 by the application for recordation and association with the user by the online system 140.

In one embodiment, the edge store 225 stores information describing connections between users and other objects in the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page in the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features also may represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate a user's interest in an object, a topic, or another user in the online system 140 based on actions performed by the user. Computation of affinity is further described in U.S. patent application Ser. No. 12/978,265, filed on Dec. 23, 2010 (U.S. Publication No. US 2012/0166532 A1, published on Jun. 28, 2012), U.S. patent application Ser. No. 13/690,254 (U.S. Pat. No. 9,070,141, issued on Jun. 30, 2015), filed on Nov. 30, 2012, U.S. patent application Ser. No. 13/689,969, filed on Nov. 30, 2012 (U.S. Pat. No. 9,317,812, issued on Apr. 19, 2016), and U.S. patent application Ser. No. 13/690,088, filed on Nov. 30, 2012 (U.S. Publication No. US 2014/0156360 A1, published on Jun. 5, 2014), each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

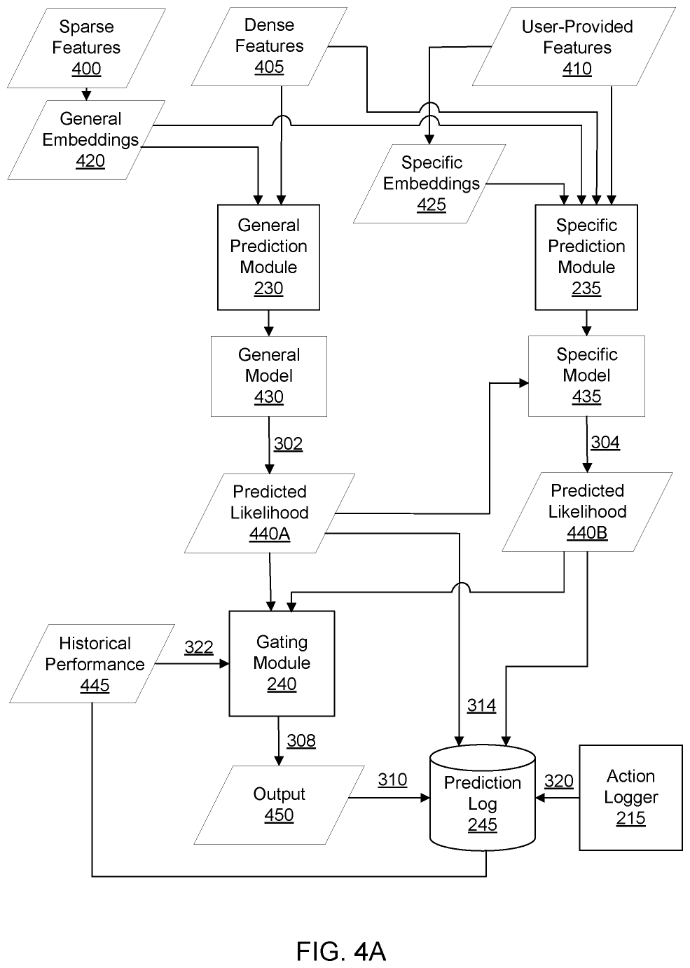

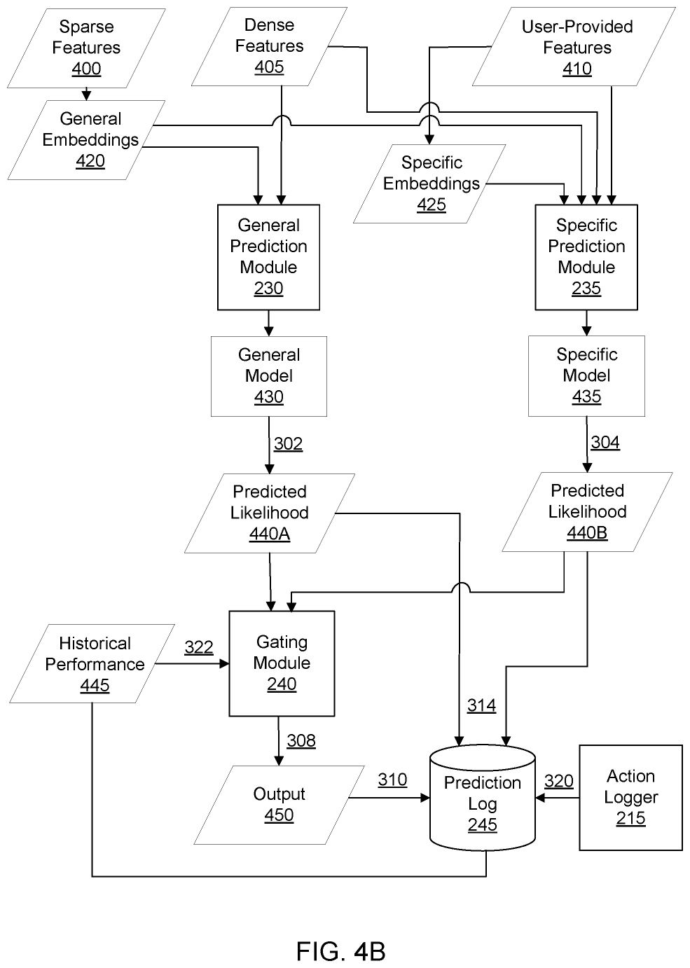

The online system 140 includes a general prediction module 230, which trains a general model used to predict (e.g., as shown in step 302 of FIG. 3) likelihoods that viewing users will interact with candidate content items. The likelihood that a viewing user will interact with a candidate content item may be expressed as an estimated click-through-rate, an estimated conversion rate, or in any other suitable manner. The general model may correspond to a machine-learning model that is trained based on a set of non-specific features maintained in the online system 140 (e.g., features that are not specific to any particular content-providing users of the online system 140). Such features may include dense features (i.e., features for which most users or advertisements are expected to have a score) and/or sparse features (i.e., features for which most users or advertisements do not have a score, such as interests or interactions with specific content objects in the system). In one example, the online system 140 requires users of the online system 140 to provide their age and geographic region when creating an account in the online system 140. In this example, the users may view, share, comment on, or otherwise engage with content maintained by the system, such as videos and other users' posts. In this example, a set of dense features that may be used to train the general model may include ages and geographic regions associated with users of the online system 140. A set of sparse features that may be used to train the model include various actions that the users have performed to engage with content in the system. In some embodiments, the general model may learn embeddings for the sparse features, where the embeddings represent the sparse features in a lower-dimensional latent space that is not sparse. The functionality of the general prediction module 230 is further described below in conjunction with FIGS. 3, 4A, and 4B.

The online system 140 also includes a specific prediction module 235 that trains a specific model used to predict (e.g., as shown in step 304 of FIG. 3) likelihoods that viewing users will interact with candidate content items. Similar to the general model, the specific model may correspond to a machine-learning model that is trained based on a set of features maintained in the online system 140 (e.g., dense and/or sparse features). Also similar to the general model, the specific model may learn embeddings for sparse features. However, the specific model may differ from the general model in that the specific model has a higher latency than the general model (i.e., the amount of time elapsed between the time the online system 140 identifies an opportunity to present content to a viewing user and the time the likelihood is predicted is greater for the specific model than for the general model). In some embodiments, the specific model has a higher latency than the general model because the specific model is more complex than the general model and therefore requires more time to predict the likelihood. In other embodiments, the specific model has a higher latency than the general model because the specific model refines the likelihood predicted by the general model. In such embodiments, inputs to the specific model include the likelihood predicted by the general model, forcing the specific model to wait for an output of the general model and thus causing more latency. Although in many cases the general model will have a higher latency than the specific model, where the specific model does not depend on any predictions from the general model (e.g., as shown in FIG. 4B) it is possible that the specific model could be computed faster than the general model.

The specific model may be more complex than the general model for various reasons. In some embodiments, the specific model may be more complex than the general model because the specific prediction module 235 may train the specific model based on additional features that are not used to train the general model. In such embodiments, some of these additional features may be provided by one or more content-providing users of the online system 140. For example, the specific model may be trained based on features including a promotion, a topic (e.g., travel), a geographic location, an industry, or any other feature that may be specific to one or more content-providing users of the online system 140. As an additional example, the general model may learn general embeddings trained to represent global patterns based on sparse non-specific features while the specific model may learn specific embeddings trained to represent patterns specific to one or more content-providing users of the online system 140 based on sparse features provided by these content-providing users. In various embodiments, the specific model may be more complex than the general model because the specific model may require more inputs than the general model. For example, the specific model may require inputs including historical information describing previous interactions by a viewing user with content items, demographic information associated with the viewing user, and attributes for users of the online system 140 connected to the viewing user in the online system 140, while the general model may require only the historical information as an input. Furthermore, in some embodiments, the specific model may be more complex than the general model because the specific model and general model may correspond to different types of machine-learning models. For example, the specific model may correspond to a neural network model while the general model may correspond to a regression model. As an additional example, the specific model may correspond to a multi-level regression model while the general model may correspond to a single-level regression model. The functionality of the specific prediction module 235 is further described below in conjunction with FIGS. 3, 4A, and 4B.

The gating module 240 may access (e.g., as shown in step 306 of FIG. 3) a control setting used to determine which prediction (i.e., the predicted likelihood from the general model or the specific model) to output. The control setting indicates whether the online system 140 should wait for the specific model to predict the likelihood by balancing the benefit of a more accurate prediction made by the specific model against the higher latency of the specific model. The gating module 240 also outputs (e.g., as shown in step 308 of FIG. 3) the predicted likelihood from the general model or the specific model based on the control setting.

The gating module 240 also may determine (e.g., as shown in step 322 of FIG. 3) the control setting. The gating module 240 may determine the control setting by comparing the accuracies of the predictions made by the specific model and the general model (e.g., by comparing their error rates). For example, the gating module 240 may access historical predicted likelihoods from the general model and the specific model (e.g., from the prediction log 245, described below) and compare the accuracies for each pair of predicted likelihoods (e.g., by performing a continuous AB experiment). Based on the comparison, the gating module 240 may compute a metric (an “accuracy comparison metric”) that measures an increased accuracy of the predicted likelihoods from the specific model compared to the predicted likelihoods from the general model. The gating module 240 may then determine the control setting based on the accuracy comparison metric, such that the control setting indicates that the online system 140 should wait for the specific model to predict the likelihood if the accuracy comparison metric is above a threshold (e.g., a threshold error rate) and indicates that the online system 140 should not wait for the specific model to predict the likelihood otherwise. In some embodiments, the threshold to which the gating module 240 compares the accuracy comparison metric may be specified by one or more content-providing users of the online system 140 associated with the specific model. For example, the threshold may be specified by content-providing users of the online system 140 who provided features used to train the specific model.

The gating module 240 also may determine the control setting based on additional factors. In some embodiments, the gating module 240 also may determine the control setting based on whether the accuracy comparison metric has stabilized. For example, if the gating module 240 has determined that the accuracy comparison metric is above a threshold, the gating module 240 also may determine whether the accuracy comparison metric has stabilized (e.g., based on the percentage of most recent accuracy comparison metrics that are above the threshold). In various embodiments, the gating module 240 may determine the control setting based on a random selection process. For example, to prevent bias in the delivery of content items to viewing users, the control setting may be set such that it does not wait for the specific model to predict the likelihood based on a random selection process that randomly selects impression opportunities for which the online system 140 outputs the predicted likelihood from the general model regardless of the accuracy comparison metric. In various embodiments, the gating module 240 also may determine the control setting based on historical performance information that indicates whether the quality of the predictions made by the specific model has degraded. For example, suppose that the specific model is trained using features provided by a set of content-providing users of the online system 140 and that after the specific model is trained, the set of content-providing users subsequently provide updated information describing these features to the online system 140. In this example, historical performance information describing the performance of the specific model (e.g., stored in the prediction log 245) may indicate that the specific model has degraded enough that the online system 140 should not wait for the specific model to predict the likelihood (i.e., the online system 140 should output the predicted likelihood from the general model). The functionality of the gating module 240 is further described below in conjunction with FIGS. 3, 4A, and 4B.

The prediction log 245 stores predicted likelihoods from the general model, predicted likelihoods from the specific model, predicted likelihoods outputted by the gating module 240, and/or information describing the performance of content items presented to viewing users (e.g., click-through rate, conversion rate, etc.). The predicted likelihoods and information describing the performance of content items may be stored in the prediction log 245 in conjunction with various types of information (e.g., information describing the time that a prediction was made, information describing the time a content item was presented to a viewing user, information identifying the general model/specific model that made a prediction, etc.). The prediction log 245 is further described below in conjunction with FIGS. 3, 4A, and 4B.

The content selection module 250 ranks (e.g., as shown in step 312 of FIG. 3) candidate content items eligible for presentation to a viewing user using the outputted predicted likelihood (e.g., in a content selection process). In various embodiments, once the gating module 240 has output the predicted likelihood from the general model or the specific model, the content selection module 250 may rank candidate content items based on values derived from the outputted predicted likelihood. For example, if the outputted predicted likelihood indicates a likelihood that a viewing user of the online system 140 will click on a candidate content item, the content selection module 250 may compute a value (e.g., a score or a bid amount) associated with the candidate content item that is proportional to the likelihood. In this example, the content selection module 250 may rank the candidate content item among a set of additional candidate content items eligible for presentation to the viewing user based on the value associated with the candidate content item and a corresponding value associated with each of the additional candidate content items.

The content selection module 250 also may select (e.g., as shown in step 316 of FIG. 3) one or more content items for presentation to a viewing user based on the ranking in a content selection process. For example, once the content selection module 250 has ranked candidate content items eligible for presentation to a viewing user, the content selection module 250 may select one or more of the highest ranked candidate content items for presentation to the viewing user. The functionality of the content selection module 250 is further described below in conjunction with FIG. 3.

The user interface module 255 may generate a display unit in which content item(s) may be presented to a viewing user. In some embodiments, the display unit may be a feed of content items (e.g., a newsfeed), a pop-up window, or any other suitable display unit in which content items selected by the content selection module 250 may be presented to viewing users of the online system 140. For example, the user interface module 255 may generate a scrollable newsfeed including one or more content items (e.g., advertisements) selected for presentation to a viewing user by the content selection module 250. The functionality of the user interface module 255 is further described below in conjunction with FIG. 3.

The web server 260 links the online system 140 via the network 120 to the one or more client devices 110, as well as to the third-party system 130 and/or one or more third-party systems 130. The web server 260 serves web pages, as well as other content, such as JAVA®, FLASH®, XML and so forth. The web server 260 may receive and route messages between the online system 140 and the client device 110, for example, instant messages, queued messages (e.g., email), text messages, short message service (SMS) messages, or messages sent using any other suitable messaging technique. A user may send a request to the web server 260 to upload information (e.g., images or videos) that are stored in the content store 210. Additionally, the web server 260 may provide application programming interface (API) functionality to send data directly to native client device operating systems, such as IOS®, ANDROID™, WEBOS® or BlackberryOS.

Balancing an Improvement in a Predicted Likelihood of User Interaction with a Content Item in an Online System Against a Latency Required to Obtain the Improved Prediction

FIG. 3 is a flow chart of a method for balancing an improvement in a predicted likelihood of user interaction with a content item in an online system against a latency required to obtain the improved prediction. In other embodiments, the method may include different and/or additional steps than those shown in FIG. 3. Additionally, steps of the method may be performed in a different order than the order described in conjunction with FIG. 3.

The online system 140 identifies 300 an opportunity to present a content item to a viewing user of the online system 140. For example, the online system 140 may identify 300 an opportunity to present a content item to a viewing user of the online system 140 upon receiving a request from the viewing user to access a user profile page associated with the viewing user. In this example, the user profile page may include a newsfeed in which various content items may be presented.

The online system 140 then predicts 302 a likelihood that the viewing user will interact with a candidate content item eligible for presentation to the viewing user using the general model trained by the online system 140 (e.g., using the general prediction module 230). As described above in conjunction with FIG. 2, the general model may correspond to a machine-learning model that is trained based on a set of features maintained in the online system 140 (e.g., dense and/or sparse features that are not specific to any particular content-providing users of the online system 140) and which may learn embeddings for sparse features. As shown in the examples of FIGS. 4A and 4B, the general model 430 may be trained by the online system 140 using the general prediction module 230 based on a set of general embeddings 420 for a set of sparse features 400 and a set of dense features 405. As also shown in these examples, once trained, the general model 430 then predicts 302 a likelihood 440A that a viewing user will interact with a candidate content item. As described above in conjunction with FIG. 2, the predicted likelihood 440A may be expressed as an estimated click-through-rate, an estimated conversion rate, etc.

Referring again to FIG. 3, the online system 140 also predicts 304 a likelihood that the viewing user will interact with the candidate content item using the specific model trained by the online system 140 (e.g., using the specific prediction module 235). As described above in conjunction with FIG. 2, the specific model also may correspond to a machine-learning model that is trained based on a set of features maintained in the online system 140 (e.g., dense and/or sparse features). As shown in the examples of FIGS. 4A and 4B, the specific model 435 is trained by the online system 140 using the specific prediction module 235 to predict 304 an additional likelihood 440B that the viewing user will interact with the candidate content item. The specific model 435 is trained based on the set of general embeddings 420 for the set of sparse features 400, the set of dense features 405, and additional features that are not used to train the general model 430. As also shown in the examples of FIGS. 4A and 4B, the specific model 435 may learn specific embeddings 425 trained to represent patterns specific to one or more content-providing users of the online system 140 based on sparse features included among the user-provided features 410.

As described above in conjunction with FIG. 2, the specific model 435 may differ from the general model 430 in several ways. In particular, the specific model 435 has a higher latency than the general model 430. As shown in the example of FIG. 4A, in some embodiments, the specific model 435 has a higher latency than the general model 430 because the specific model 435 receives the predicted likelihood 440A as an input from the general model 430 and refines it. In other embodiments, as shown in the example of FIG. 4B, the specific model 435 has a higher latency than the general model 430 because the specific model 435 is more complex than the general model 430 and predicts 304 the likelihood 440B independent of the predicted likelihood 440A from the general model 430. The specific model 435 may be more complex than the general model 430 because the specific model 435 requires more inputs than the general model 430, because the specific model 435 has multiple model layers while the general model 430 does not, and/or because the general model 430 and the specific model 435 correspond to different types of machine-learning models.

Referring back to FIG. 3, the online system 140 may access 306 (e.g., using the gating module 240) a control setting indicating whether the online system 140 should wait for the specific model 435 to predict 304 the likelihood 440B that the viewing user will interact with the candidate content item. As described above in conjunction with FIG. 2, the control setting balances the benefit of a more accurate prediction made by the specific model 435 against the higher latency of the specific model 435. Based on the control setting, the online system 140 outputs 308 (e.g., using the gating module 240) the predicted likelihood 450 from the general model 430 or the specific model 435 and may log 310 the outputted predicted likelihood 450 (e.g., in the prediction log 245), as shown in FIGS. 4A and 4B.

Referring back to FIG. 3, the online system 140 passes the outputted predicted likelihood 450 to a content selection process that ranks 312 (e.g., using the content selection module 250) the candidate content item among additional candidate content items eligible for presentation to the viewing user using the outputted predicted likelihood 450. In various embodiments, the online system 140 may rank 312 the candidate content items based on a value (e.g., a score or a bid amount) derived from the outputted predicted likelihood 450. Regardless of the predicted likelihood 440 that is output 308, the online system 140 logs 314 both predictions 440 (e.g., in the prediction log 245), as shown in FIGS. 4A and 4B. As shown in FIG. 3, the online system 140 may select 316 (e.g., using the content selection module 250) one or more content items for presentation to the viewing user based on the ranking in the content selection process. The online system 140 may then send 318 the selected content item(s) for presentation to the viewing user (e.g., in a newsfeed or other display unit generated by the user interface module 255). The online system 140 subsequently may log 320 (e.g., using the action logger 215) the performance of the content item (e.g., in the prediction log 245), as shown in FIGS. 4A and 4B.

Referring again to FIG. 3, in some embodiments, the online system 140 may determine 322 (e.g., using the gating module 240) the control setting used to determine which prediction to output 308 (e.g., upon subsequently identifying 300 another opportunity to present a candidate content item to a viewing user of the online system 140). As described above in conjunction with FIG. 2, the online system 140 may determine 322 the control setting by comparing the accuracies of the predictions (e.g., by comparing their error rates). For example, as shown in FIGS. 4A and 4B, the online system 140 may use the gating module 240 to access information describing the historical performance 445 of the predicted likelihoods 440 from the general model 430 and the specific model 435 (e.g., stored in the prediction log 245) and compare the accuracies for each pair of predicted likelihoods 440 (e.g., by performing a continuous AB experiment). In this example, the online system 140 may then compute an accuracy comparison metric that measures an increased accuracy of the predicted likelihoods 440B from the specific model 435 compared to the predicted likelihoods 440A from the general model 430 and determine 322 the control setting based on the accuracy comparison metric, such that the control setting indicates that the online system 140 should wait for the specific model 435 to predict 304 the likelihood 440B if the accuracy comparison metric is above a threshold (e.g., a threshold error rate) and indicates that the online system 140 should not wait for the specific model 435 to predict 304 the likelihood 440B otherwise. As also described above in conjunction with FIG. 2, the online system 140 also may determine 322 the control setting based on additional factors, such as whether the accuracy comparison metric has stabilized, based on a random selection process, and based on historical performance information 445 that indicates whether the quality of the predictions made by the specific model 435 has degraded.

Referring once more to FIG. 3, in some embodiments, the online system 140 may repeat some of the steps described above (e.g., by proceeding back to the identifying 300 an opportunity to present a candidate content item to a viewing user of the online system 140 step).

### Summary

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A method comprising:
training a general model based on a first set of training examples to predict a likelihood that a viewing user will interact with a content item, wherein each training example of the first set of training examples comprises values for a first set of features for a user and a label indicating whether the user interacted with a content item;
training a specific model based on a second set of training examples to predict a likelihood that a viewing user will interact with a content item, wherein each training example of the second set of training examples comprises values for a second set of features for a user and a label indicating whether the user interacted with a content item;
identifying a plurality of opportunities to present content to a plurality of users of an online system; and
for each of a plurality of opportunities to present a candidate content item to a viewing user of the plurality of users:
predicting the likelihood that the viewing user will interact with the candidate content item by applying the general model to the first set of features,
predicting the likelihood that the viewing user will interact with the candidate content item by applying the specific model to the second set of features concurrently with applying the general model to the first set of features, where the specific model has higher latency than the general model, and wherein the second set of features is different from the first set of features,
accessing a control setting that indicates whether to wait for the specific model to predict the likelihood,
outputting the predicted likelihood from the general model or the specific model based on the control setting,
passing the outputted predicted likelihood for the candidate content item to a content selection process that ranks the candidate content item for presentation to the viewing user, and
logging the predicted likelihoods of the general model and the specific model.

2. The method of claim 1, further comprising:
accessing the logged predicted likelihoods of the general model and the specific model;
for each of a plurality of pairs of predicted likelihoods of the general model and the specific model, comparing an accuracy of the predicted likelihoods of the general model and the specific model, and
computing an accuracy comparison metric based on the compared accuracies, the accuracy comparison metric comprising a measure of increased accuracy of the predicted likelihoods from the specific model compared to the predicted likelihoods from the general model.

3. The method of claim 2, further comprising:
determining the control setting based at least in part on the accuracy comparison metric, the control setting indicating to wait for the predicted likelihood from the specific model only if the accuracy comparison metric is above a threshold.

4. The method of claim 2, wherein the control setting is based at least in part on a set of historical performance information indicating whether a quality of the specific model has degraded.

5. The method of claim 1, further comprising:
sending a content item selected by the content selection process for presentation to the viewing user; and
logging information describing a performance of the content item.

6. The method of claim 1, wherein the general model comprises a set of general embeddings trained based at least in part on a set of features associated with a plurality of content-providing users of the online system.

7. The method of claim 6, wherein the specific model comprises a set of specific embeddings trained based at least in part on a set of features provided by one or more of the plurality of content-providing users of the online system.

8. The method of claim 1, wherein the higher latency of the specific model offsets a measure of increased accuracy of the predicted likelihoods from the specific model compared to the predicted likelihoods from the general model.

9. The method of claim 1, wherein the control setting indicates not to wait for the specific model to predict the likelihood based at least in part on a random selection process.

10. The method of claim 1, wherein the higher latency comprises an amount of time elapsed between identifying each of the plurality of opportunities to present the candidate content item to the viewing user and outputting the predicted likelihood from the general model or the specific model.

11. The method of claim 1, wherein the predicted likelihood from the specific model comprises a refinement of the predicted likelihood from the general model.

12. A computer program product comprising a computer readable storage medium having instructions encoded thereon that, when executed by a processor, cause the processor to:
train a general model based on a first set of training examples to predict a likelihood that a viewing user will interact with a content item, wherein each training example of the first set of training examples comprises values for a first set of features for a user and a label indicating whether the user interacted with a content item;
train a specific model based on a second set of training examples to predict a likelihood that a viewing user will interact with a content item, wherein each training example of the second set of training examples comprises values for a second set of features for a user and a label indicating whether the user interacted with a content item;
identify a plurality of opportunities to present content to a plurality of users of an online system; and
for each of a plurality of opportunities to present a candidate content item to a viewing user of the plurality of users:
predict the likelihood that the viewing user will interact with the candidate content item by applying the general model to the first set of features,
predict the likelihood that the viewing user will interact with the candidate content item by applying the specific model to the second set of features concurrently with applying the general model to the first set of features, where the specific model has higher latency than the general model, and wherein the second set of features is different from the first set of features,
access a control setting that indicates whether to wait for the specific model to predict the likelihood,
output the predicted likelihood from the general model or the specific model based on the control setting,
pass the outputted predicted likelihood for the candidate content item to a content selection process that ranks the candidate content item for presentation to the viewing user, and
log the predicted likelihoods of the general model and the specific model.

13. The computer program product of claim 12, wherein the computer readable storage medium further has instructions encoded thereon that, when executed by the processor, cause the processor to:
access the logged predicted likelihoods of the general model and the specific model;
for each of a plurality of pairs of predicted likelihoods of the general model and the specific model, compare an accuracy of the predicted likelihoods of the general model and the specific model, and
compute an accuracy comparison metric based on the compared accuracies, the accuracy comparison metric comprising a measure of increased accuracy of the predicted likelihoods from the specific model compared to the predicted likelihoods from the general model.

14. The computer program product of claim 13, wherein the computer readable storage medium further has instructions encoded thereon that, when executed by the processor, cause the processor to:
determine the control setting based at least in part on the accuracy comparison metric, the control setting indicating to wait for the predicted likelihood from the specific model only if the accuracy comparison metric is above a threshold.

15. The computer program product of claim 13, wherein the control setting is based at least in part on a set of historical performance information indicating whether a quality of the specific model has degraded.

16. The computer program product of claim 12, wherein the computer readable storage medium further has instructions encoded thereon that, when executed by the processor, cause the processor to:
send a content item selected by the content selection process for presentation to the viewing user; and
log information describing a performance of the content item.

17. The computer program product of claim 12, wherein the general model comprises a set of general embeddings trained based at least in part on a set of features associated with a plurality of content-providing users of the online system.

18. The computer program product of claim 17, wherein the specific model comprises a set of specific embeddings trained based at least in part on a set of features provided by one or more of the plurality of content-providing users of the online system.

19. The computer program product of claim 12, wherein the higher latency of the specific model offsets a measure of increased accuracy of the predicted likelihoods from the specific model compared to the predicted likelihoods from the general model.

20. The computer program product of claim 12, wherein the control setting indicates not to wait for the specific model to predict the likelihood based at least in part on a random selection process.

21. The computer program product of claim 12, wherein the higher latency comprises an amount of time elapsed between identifying each of the plurality of opportunities to present the candidate content item to the viewing user and outputting the predicted likelihood from the general model or the specific model.

22. The computer program product of claim 12, wherein the predicted likelihood from the specific model comprises a refinement of the predicted likelihood from the general model.

23. A method comprising:
training a general model based on a first set of training examples to predict a likelihood that a viewing user will interact with a content item, wherein each training example of the first set of training examples comprises values for a first set of features for a user and a label indicating whether the user interacted with a content item;
training a specific model based on a second set of training examples to predict a likelihood that a viewing user will interact with a content item, wherein each training example of the second set of training examples comprises values for a second set of features for a user and a label indicating whether the user interacted with a content item; and
for each of a plurality of opportunities to present a candidate content item to a viewing user of an online system:
predicting the likelihood that the viewing user will interact with the candidate content item by applying the general model to the first set of features,
predicting the likelihood that the viewing user will interact with the candidate content item by applying the specific model to the second set of features concurrently with applying the general model to the first set of features, where the specific model has higher latency than the general model, and wherein the second set of features is different from the first set of features,
outputting the predicted likelihood from the general model or the specific model based on a control setting that indicates whether to wait for the specific model to predict the likelihood, and
passing the outputted predicted likelihood for the candidate content item to a content selection process that ranks the candidate content item for presentation to the viewing user.
